(19) United States
(12) Patent Application Publication
(10) Pub. No.: US 2020/0382572 A1
(43) Pub. Date: Dec. 3, 2020

(54) DIGITAL SIGNAL PROCESSING CODE DISTRIBUTION METHOD AND SYSTEM

(71) Applicant: Roli Limited, London (GB)

(72) Inventors: Julian STORER, London (GB); Ceasare FERRARI, London (GB)

(73) Assignee: Roli Limited, London (GB)

(21) Appl. No.: 16/430,247

(22) Filed: Jun. 3, 2019

(51) Int. Cl. H04L 29/06; G06F 8/41; G06F 8/51; G06F 9/38; G06F 16/901

(52) U.S. Cl. CPC H04L 65/604; G06F 8/47; G06F 16/9024; G06F 9/3822; G06F 8/51

(57) ABSTRACT

In a method for distributing digital signal processing (DSP) code, DSP source code is received at an application programme interface (API), the DSP source code being written in a first programming language. The DSP source code is translated into an intermediate representation (IR), wherein the IR comprises a directed-graph (di-graph) representation of the DSP source code, the di-graph comprising a plurality of nodes and connections, where each node comprises a DSP program for performing a signal processing task. A target device which advertises its ability to execute the IR is detected. The IR is transmitted to the detected target device for execution.

### FIELD

The present disclosure relates generally to a method and apparatus for distributing digital signal processing code to one or more target devices.

### BACKGROUND

Systems which perform digital signal processing (DSP) processes on an input data stream are often required to operate in a real-time context. In such a scenario, a continuous stream of input samples is required to be processed to produce a constant stream of output samples without an increase in processing delay over time.

Existing solutions for writing and distributing DSP code, for example in audio, include preparing DSP code which may be executed at one of various hardware platforms, each of which may have different device characteristics. This therefore requires that all possible platforms are known at build time so that compatible code can be generated. It is often impossible to know whether DSP code will work on a particular future target device; ensuring compatibility with multiple target machines requires complex toolchains be built and this inherently slows down the development process.

### BRIEF DESCRIPTION OF THE DRAWINGS

Examples of the present disclosure will now be explained with reference to the accompanying drawings in which:

FIG. 1 shows a block diagram of a system for implementing the methods described herein;

FIG. 2 shows a block diagram of a system for implementing the methods described herein;

FIG. 3 shows a block diagram of a system for implementing the methods described herein;

FIG. 4 shows a block diagram of a system for implementing the methods described herein;

FIG. 5 shows an example of a directed graph for use in performing the methods described herein;

FIG. 6 shows a flow chart describing a method of distributing DSP code;

FIG. 7 shows a further flow chart describing a method of executing distributed DSP code,

FIG. 8 shows the components of a computer that can be used to implement the methods described herein.

Throughout the description and the drawings, like reference numerals refer to like parts.

### DESCRIPTION OF EXAMPLE EMBODIMENTS

### Overview

A method of distributing digital signal processing (DSP) code is described herein. The method comprises providing DSP code to an application programming interface (API), translating the DSP code into an intermediate representation (IR) which is a directed graph (di-graph) representation of the DSP code comprising a plurality of nodes and connections. Each node of the di-graph contains a DSP program for performing a respective DSP task. The method further comprises detecting a target device which has advertised its ability to execute the IR, and transmitting the IR to the target device for execution.

A system is described, comprising a user device and a target device, the system being arranged to perform the method.

### Example Embodiments

There are many examples of systems on which a user may wish to execute DSP source code in order to produce an output. The way in which the DSP code is designed and distributed depends, in a known context, on the requirements of the system on which the code is to be executed. Therefore, the code must be made as robust as possible in order that errors do not occur at runtime, and this leads to poor or unreliable performance. In this way, present methods of distributing DSP code attempt to mitigate the effects of variation in target devices which are often unknown to the producer of the code.

The processing of the DSP code can, however, be modified from the known methods by executing the code by having an API create an intermediate representation (IR) of the code.

An API as employed in the systems and methods described herein communicates via a bespoke communication protocol. The bespoke communication protocol is used by the API to determine whether and what compatible target devices exist for the execution of the IR code created in the API. To be compatible with the IR code, a target device must comprise means for executing the IR code to produce the DSP output. In practice, a target device may comprise software instructions that allow the input/output and processing resources of the device to be targeted by a client application. The means for executing the IR code may be a JIT compiler. The target device must be arranged to utilise the bespoke API protocol in order to be recognised by the API and communicate with the API.

The API may detect devices by detecting connection of a target device to a host, for example via connection of a target device into a USB connection terminal, or other direct connection, on the host. In this case, a device driver on the host computer device will detect the target device directly, using standard methods. If a target device is a network device, device discovery may be via mDNS protocol.

The API may communicate the IR to a target device using the bespoke communication protocol, and opens up one or more communication channels for the streaming of continuous digital sample data and control event data to the target device while the IR code is being executed at the target device.

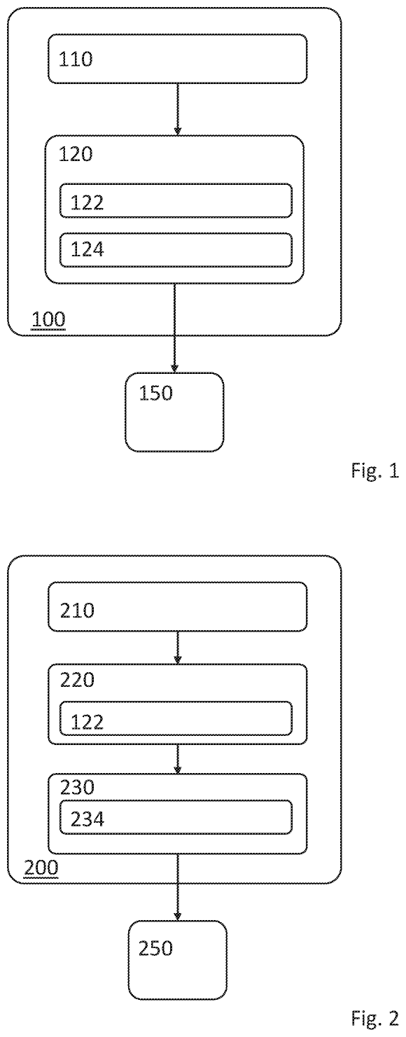

FIG. 1 is a block diagram of a system which is adapted to perform a method as described herein. The system comprises a user device 100, having an API 120 thereon.

The DSP source code which is to be processed, distributed and executed may be developed at a user application 110 provided on user device 100. The DSP source code may relate to any signal processing code, or may specifically relate to audio DSP. The user application 110 provides the DSP code to an application programme interface (API) 120 in a first programming language. The first programming language may be a special-purpose language for signal processing applications only. The API 120 comprises a compiler 122 and optionally a just in time (JIT) engine 124.

The compiler 122 is arranged to translate the DSP source code in the first language into an intermediate representation (IR) of the source code. The IR may be described as a second language, and may itself be DSP code.

The IR may comprise a directed graph, di-graph, representation of the DSP source code in the first language. The IR di-graph comprises a series of nodes and connections which define one or more program paths which determine how data input to the di-graph is treated. The IR represents a DSP code via a series of data threads or data flows.

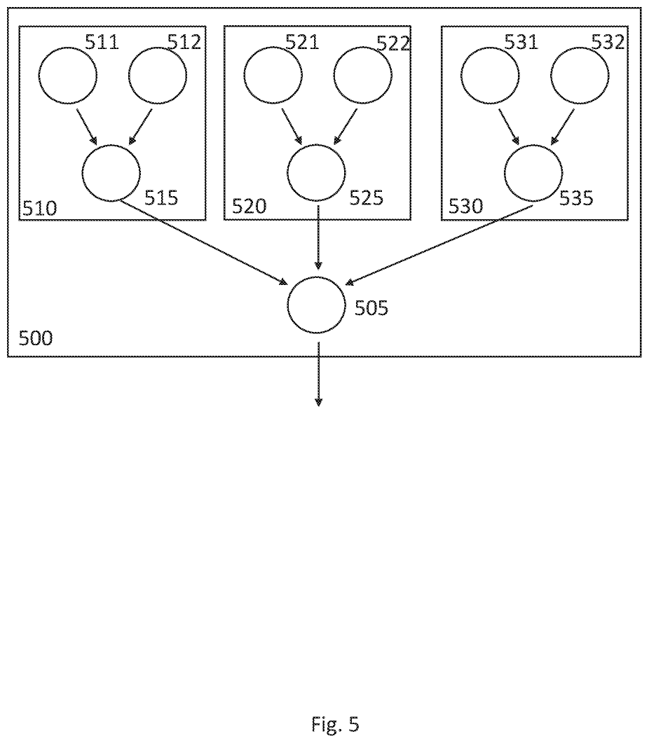

FIG. 5 shows an example di-graph in the context of audio DSP.

Once the compiler 122 has translated the DSP into the IR di-graph, the API attempts to detect whether a device which is compatible with the first language, or compatible with the IR. That is to say, the API matches the requirements of the IR with that of the found devices. Requirements compared may include one or more of device inputs, device outputs, midi support, available memory and stack space requirements.

The API may determine that no compatible device is connected. In this case, the API calls JIT engine 124, if the best available device is in-process rendering. Where such a determination is made, the compiler passes the IR to the JIT engine 124 to execute the code internally on the computer 100.

The JIT engine 124 executes the code, and is arranged to operate in the second language, that is the language of the IR. The DSP output of the JIT engine may then be passed on to any output devices 150 which are connected to the user device. FIG. 1 shows a system whereby IR code is created from DSP source code in a cross-platform secondary language, being compiled for execution within the API 120, and passed to a standard output device 150, such as a loud speaker.

The JIT engine may be an LLVM-compatible compiler.

The first language in which the DSP code is written may support DSP specific features, including float and fixed point calculation, accelerated fast-Fourier transforms (FFTs), etc. The first language may further comprise vector primitives and multi-processing support. The first language does not require platform specific requirements and extensions such as threading or synchronisation primitives, system calls, and blocking operations.

The user device 100, in FIG. 1 and also in the systems described below, may be a computer comprising one or more processors, a memory, user input device, and a display (not shown). User device may also be a laptop computer, tablet, smartphone, mobile device or other computing device. The memory, for example a random access memory (RAM), is arranged to be able to retrieve, store, and provide to the processor, instructions and data that have been stored in the memory.

FIG. 2 shows a further system designed for the distribution and execution of DSP code. Like the system shown in FIG. 1, the system may comprise a user application 210, and an API 220 running on a user computer device 200, the API being arranged to receive DSP code. The API 220 compiles the DSP code, translating it from the first language into the IR. The API is arranged to request information from any device which is adapted to execute the IR. System 200 further comprises an IR-aware device driver 230. The API is arranged to transmit the IR of the DSP source code to driver 230, upon identifying that IR-aware driver is present in the system.

An IR-aware device driver is one that natively supports compilation and running of the IR code. When a program using the IR runs on a host without the audio driver supporting the IR, the API must compile and execute the code itself. With an IR aware device driver, the API will pass the IR code to the driver for compilation and execution. This has the benefit of avoiding the need for a context switch into the user application to generate audio data, the driver having the means to generate the audio buffer using the provided IR code.

The API 220 is arranged to communicate with the driver 230 so as to transmit control messages along with the IR itself. The control messages are used to control and monitor the code while it is running. These will be described further below.

Driver 230 comprises a JIT engine 234 arranged to execute the IR code in real-time to produce any DSP output resulting from executing the IR, and pass it to output device 250. Driver 230 is arranged to communicate with the API to deliver performance and error messages about the running code. Since IR-aware driver 230 is specifically designed to accept the IR code, it can execute it with greater performance and latency than possible in the system of FIG. 1 in which the IR is executed within a user application, or within the API itself, having to make use of the CPU of computer device 100.

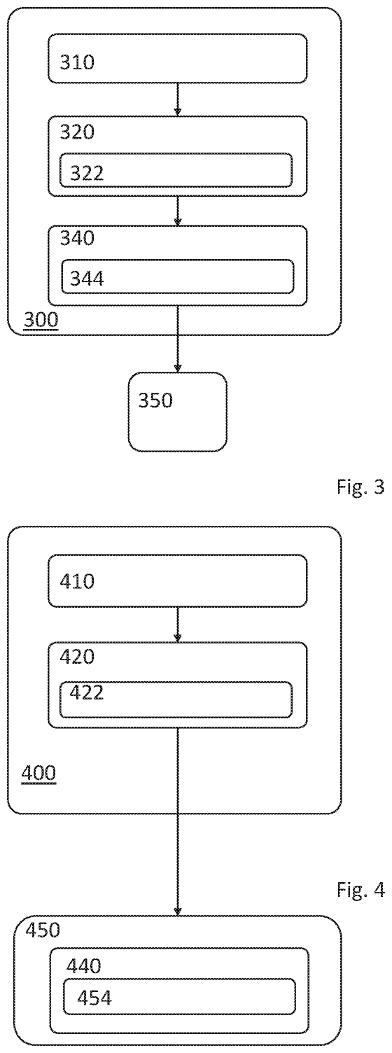

FIG. 3 shows a further system designed for the distribution and execution of DSP code. System 300 comprises a DSP device which is arranged to operate specifically on data written in the first language and in the IR. Similar to the systems shown in FIGS. 1 and 2, a user writes an application in user application 310 which comprises DSP code which is passed to, and received by API 320. API 320 comprises a compiler 322 which is arranged to translate the DSP code into an IR.

API 320, may request and receive device identification information from DSP 340, and once it detects that DSP device 340 is present in the system, through one or more of the methods outlined in the foregoing, it establishes a communication channel. API 320 transmits the IR code to DSP 340, whereupon the IR code is executed by JIT engine 344. The JIT engine 344 executes the IR code on DSP device 340 to produce the DSP output, which can then be transmitted to any playout or output device 350, such as a display or speaker.

In the systems shown in FIGS. 2 and 3, it will be appreciated by the skilled person that the IR code is able to be executed away from the application space of the computing device, and in the driver or kernel itself. Because a driver may be provided with kernel access privileges, the driver may be arranged to execute the IR in various different ways, in order to increase its efficiency. For example, the IR can be executed on a kernel interrupt, or the kernel may turn off interrupts altogether, or may be executed with a thread priority which is not available to user code in a general purpose language, in order to maximise the efficiency of the running code. This also presents the opportunity to reduce the amount of memory buffer copying at run-time which improves run-time performance. Where, for example, the DSP code is audio DSP code, this provides measurable improvements in latency when the code is executed.

The IR may be a secure language. This secure language may be passed to the kernel without the need for “sandboxing”. By removing the sandbox, context switches into the code may be faster, reducing latency, and also introducing less overhead, which improves the power efficiency of the processor running the IR code.

FIG. 4 shows yet a further system designed for the distribution and execution of DSP code. In FIG. 4, API 420 receives a portion of DSP code in a first language from a user application 410, and is adapted to translate the DSP code into an IR using a compiler 422. The API 420 then performs target device discovery as outlined above. External target device 450 may respond to the request, or may automatically advertise itself to device 400 at regular intervals, or at scheduled times. Target device 450 provides an indication to the API that it is arranged to execute the DSP code locally at that device.

The API 420 then makes use of a network connection, to provide the DSP code to the external target device 450. The external target device may be provided with specific DSP processing capability arranged to operate in the first language. Target device 450 may comprise a specific audio DSP device 440, which may comprise a JIT engine 454 for compiling the DSP code at the device at run-time.

In the system shown in FIG. 4, the API 420 may be arranged to transmit control messages across the network or other connection to the target device.

In the system of FIG. 4, the API sends control data and control messages to the target device to control the running code, but it will be appreciated that it significant local processor resources at device 400 will not be required in order to do so. Target device 450 communicates control data and any error messages to the API 420.

Where system 400 is employed in an audio application, the external device may effectively reduce the system's overall latency since the network does not need to carry audio stream data. The network connection is only required for control messages while the code is running on the device.

It can be seen that the systems outlined in FIGS. 1 to 4 comprise an API which is able to determine the location in which the DSP code may be most efficiently executed. This is achieved through the translation of the DSP code in the first language at the API, and then the discovery of a target device on which to execute the IR code. Once it is determined that a particular target device has the most efficient run-time credentials, the API establishes communication with the target device. The target device therefore is arranged to execute the IR code which means that it comprises a JIT compiler engine which is compatible with the IR, and it is arranged to communicate with the API to receive and send control event data and other messages across a communications link. In all of the embodiments shown in FIGS. 1 to 4, code is received from a user application, this may be local to the computer devices, or connected by any local or wide area network, or connected by the internet.

The API 120, 220, 320, 420, monitors network and other connections to discover target devices, and sends the DSP code or the IR code to be executed at the external device, in dependence on the characteristics of the target device. The API 120, 220, 320, 420, may also comprise its own proprietary JIT engine for compiling the DSP code and executing the IR in the case that no target device is found.

A target device may be physically located in the same device (100, 200) as the API, and therefore the communication channel for communication with the API may be wired or internal to the computer device. The target device may be external and therefore the IR code and control data may be transmitted to the target device through other connection means, including over a Wi-Fi connection, a Bluetooth® connection, via a USB connector or otherwise. In an audio DSP example, the target device communicates to the API that it comprises an audio interface compatible with the IR code.

The API may therefore be effectively arranged to offload the DSP code to the best device having a compatible audio interface. This means that any application code written in the first language and received at the API may be offloaded by default, and the DSP code in the first language is therefore device agnostic. It may be compiled and run locally on the user device 100, 200, or it may be transmitted to an external device for execution there.

The above description relates to 4 possible alternative arrangements and it will be appreciated that the features of any one embodiment may be present in the others, where appropriate.

Communication between the API of the systems and methods described and the compatible target device is bi-directional. Examples of data communication which can flow along communication link in an audio DSP example are as follows:

(1) Streams of audio data, both inputs to and outputs from the nodes forming the graph of the executing code;

(2) Control events—these may be functions added to the DSP code which receive calls with potentially complex data messages at specific moments in time. The API message specifies not only the data, but the exact sample to apply the message to the running code, A typical use may be to submit midi messages, or parameter change (say a volume control). Control events can be generated and emitted by the running audio DSP code as well as received.

3) Resource requests—the audio-DSP code can depend on external data, such as samples. As part of the runtime events can be received to provide a given resource, and a response will include this data.

4) Control events can be submitted to control the running of the code, such as ‘start’, ‘pause’, ‘stop’.

5) Control events that can be received indicating a problem in the runtime. A typical example would be to indicate a problem with the target device, such as a buffer underrun (when audio cannot be processed quickly enough) and CPU utilisation information to indicate how loaded the device is.

The intermediate representation of the DSP source code will now be described. The IR is structured as a directed graph which comprises processing nodes and graph connections between the nodes. The IR created by the API specifies a graph, and therefore the implied data flow within the graph, but the di-graph need not specify an evaluation order or any parallelism requirements.

Each node of the di-graph may be a processor node or a graph node. A node may comprise an input and an output, i.e. sample data may be provided to a node at its input, the data may be acted upon by the node, and the node will then output the processed sample data.

A processor node may comprise a set of low level instructions. The processor node is effectively a program which, when executed on a target device, performs at least the following tasks: continuously reading from the node's inputs (if required); performing some arbitrary processing on this data, and writing data to the node's outputs.

A graph node may be a nested program also in the IR language. Graphs define a collection of constituent graphs and processors, and the connections between them. In addition, graph syntax allows additional properties to be attached to nested graphs and processors, such as oversampling rates, and stream interpolation strategies.

FIG. 5 shows an example di-graph in the context of audio DSP. FIG. 5 shows a plurality of nodes within a graph with connections between nodes indicating the implied data flow within the graph.

The simplest graph would be a single node, and in such a processor represented by the node receives some input, performs its processing on the input, and creates an output. FIG. 5 shows a more complicated example of a nested graph, using processors as circles and graphs as rectangles. The example graph is an arrangement for a polyphonic synthesiser with three voices, shown as three nested graphs 510, 520, 530. Each of the voices comprises processor nodes arranged to operate on an input signal in a way defined in the original user-created DSP code, the processor nodes are summed at a further processor node to produce a voice output. For example graph 510 comprises oscillators 511, 512, and a gain 515. Each of the oscillators outputs is passed to gain 515 which provides the output of graph 510 to gain 505. Similar operations are performed in graphs 520, 530. Graph 520 may comprise oscillators 521, 522, and a gain 525, and provides its output to gain 505. Graph 530 may comprise oscillators 531, 532 and gain 535, and the output of graph 530 is also passed to gain 505. Gain 505 sums the three voices to produce a polyphonic output of graph 500. The data flow is as indicated by the arrows.

It will be appreciated by the skilled person that the graph shown in FIG. 5 lends itself to parallelisation. The processing required to render each of graphs 510, 520 and 530 is not required to take place on a single processor. If it is determined that a target device comprises multiple processor cores, the rendering of the separate elements may take place on separate cores. It will be appreciated that, according to the method disclosed herein, a graph such as that shown in FIG. 5 might be parallelised in any number of ways, in order to maximise the efficiency of the rendering of the IR code. A nested graph might be a JIT engine forming part of the systems and methods outlined herein is compatible with the IR created by the API's compiler. The confirmation that the JIT engine is compatible with the API IR is sent by the respective DSP device driver, the DSP device itself or the external target device shown in FIGS. 2 to 4.

The JIT engine is aware of its local context. This means that the JIT comprises information regarding the processor capabilities available for use at run-time. It will also be aware of the audio and midi hardware support on the platform, and hence what capabilities are exposed to connecting clients. this might include, for example, a number of available input and output channels, sample rates supported, and latency information.

The JIT engine may comprise a graph analysis module arranged to analyse the graph structure of the received IR, in order to determine an optimum way to execute the IR code.

JIT engine may further comprise a parallelisation module. Where multiple processor cores are available on the target device, the parallelisation module may be arranged to control load across cores when the code is to be executed, and to control the location of the executing code itself.

The parallelisation module may be arranged to identify that a plurality of data flows, or data paths, through the graph may be subject to parallelisation. The parallelisation module may be arranged to parallelise the data flows, to effectively separate various parts of the graph and assign the task of executing the particular data flows to a respective processor core or cores.

The JIT engine may further comprise a load analysis module arranged to perform load analysis on the cores which are available to it, and be adapted to modify the parallelisation of the graph data flows based upon the load analysis. In this way, the system is optimised for execution of the IR code, since it is executed at a location remote from the CPU of the user computing device and the API.

The graph analysis module may be arranged to determine that a graph is inherently serial, and thus impossible to parallelise. Upon such a determination, JIT engine may be arranged to split the execution of the graph across multiple cores. The splitting of the graph across multiple cores will provide a performance improvement for the running cores at the cost of a latency increase. The decision to split the graph may be automatically taken where it is determined that the resulting increase in latency is lower than a predetermined threshold. Where splitting a graph would result in an increase in latency that would exceed the predetermined threshold, the code may be implemented on a single core.

The fact that the target device characteristics are used at the JIT engine stage means that the DSP code received at the API need not contain any evaluation of the system on which the DSP code, or IR code, is to be executed.

Device characteristics may include any of number or processor cores, processor core speeds available, usable memory, number of inputs, number of outputs etc.

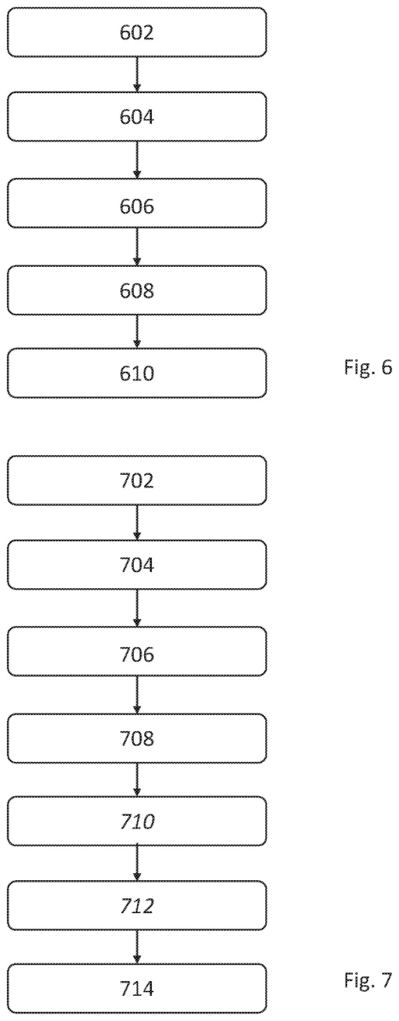

FIG. 6 shows a flow diagram describing a method for distributing DSP code. At step 602, DSP code is received at an API. The DSP code may be written in a first language, and the first language may be specifically created for signal-processing, and not a general purpose language. DSP code may be received at API from a user application on a user computing device. At step 604 the API translates the DSP code into a di-graph structure intermediate representation (IR) of the DSP code. At step 606 the API sends a target device identification request, to determine the devices which are in range and compatible so as to execute the IR. At step 608 the API receives one or more target device ID responses from one or more target devices. The device ID responses may include system characteristics of the target device. Where more than one device ID response is received, the API may determine that a particular device is best equipped to execute the code. This determination may be based on a number of cores present in a responding target device, or a processor speed.

At step 610 the API transmits the IR code to the identified target device that has advertised its ability to execute the IR code, in order that the code may be run at the target device.

The target device may then execute the IR code to produce the DSP output. A communication channel may be established between the API and the target device prior to the transmission of the IR code. When the IR code is being executed at the target device, control data may be sent to from the API to the target device, as described above.

It will be appreciated that any target device compatible with the IR, and adapted to execute the IR code, may be arranged to automatically or periodically advertise its presence to the API, such that step 606 may be optionally not required.

A further method is described in FIG. 7. A target device having means for processing DSP code is arranged to receive a request for device characteristics from an API at step 702. The request may be make use of a communication protocol recognised by the target device. The target device provides to the API a notification identifying itself and providing its device characteristics at step 704. In identifying itself, the target device may instantiate a communication link to the API using the communication protocol.

At step 706 the target device receives IR code from the API. The IR code is in the form of a di-graph of nodes and connections, the nodes and connections defining one or more code paths or threads through the graph which define DSP functions which are to be performed on input data. The target device comprises a JIT engine operable to execute the IR code.

At step 708 a graph analysis module of the target device analyses the IR code to determine the data threads present in the IR graph.

Optionally, at step 710, a parallelisation module determines that one or more threads may be run in parallel across different processor cores present in the target device. Optionally, at step 712, the graph analysis module determines that a graph or a portion of the graph is inherently serial and incapable of parallelisation. Graph analysis module may then determine that the inherently serial graph or portion may be divided for execution across two or more processors. This determination includes calculating a processing overhead which results from splitting the code to be run on separate processor cores. If this processing overhead is less than a predetermined threshold, the JIT engine may execute the IR code serially, with portions being run on separate cores.

The target device executes the code at 714, and may pass the output to an output device, such as, in the case of audio DSP, a loudspeaker.

Target device may be any device adapted to process DSP code. It may form part the user device, and be an audio driver. Alternatively it may be a DSP processor specially adapted to operate on IR code created by the API. The DSP processor may be local or on a remote device. A remote device might be a loudspeaker having local capability to process the IR code. Remote device may be a pair of Bluetooth® enabled headphones and the communication channel may be established via a Bluetooth® connection.

The above systems describe various discrete options for an arrangement of the features of the host computer device, API arranged to receive source code, and a JIT engine shown located at various locations from within the API itself, to being located on an external hardware device. The API of the systems disclosed herein is arranged to detect the one or more devices which may be able to run the IR code it generates. It may be that a system being a combination of any or all of those shown in FIGS. 1 to 4 is present. In this case the API is adapted to select among the optional locations for rendering the IR code to produce the DSP output. The API may determine that the IR code is not suitable for rendering on a detected external device, and where “on-host” rendering is supported (i.e. the JIT engine is present on the host), this option may be selected. In general, the API may be arranged to select the device which places the lowest demand on the processor of the host device on which it is running.

The above systems and methods describe an approach for distributing DSP code has the advantage that network bandwidth requirements may be reduced when running DSP code.

The described approach has the advantage that system latency may be reduced in a context where audio DSP is being processed.

The described approach has the advantage that DSP code may be made more versatile than in existing systems and approaches. The described approach improves particularly on existing systems for processing audio DSP code and rendering audio, providing a method which allows for a user to create a DSP code which need not be modified to suit each individual and possible hardware set-up on which it might be eventually rendered. Rather, not only can the DSP processing take place on the most appropriate device thanks to the detecting of devices and selection by the API, that processing can be optimised thanks to the nature of the IR created by the API, as described above.

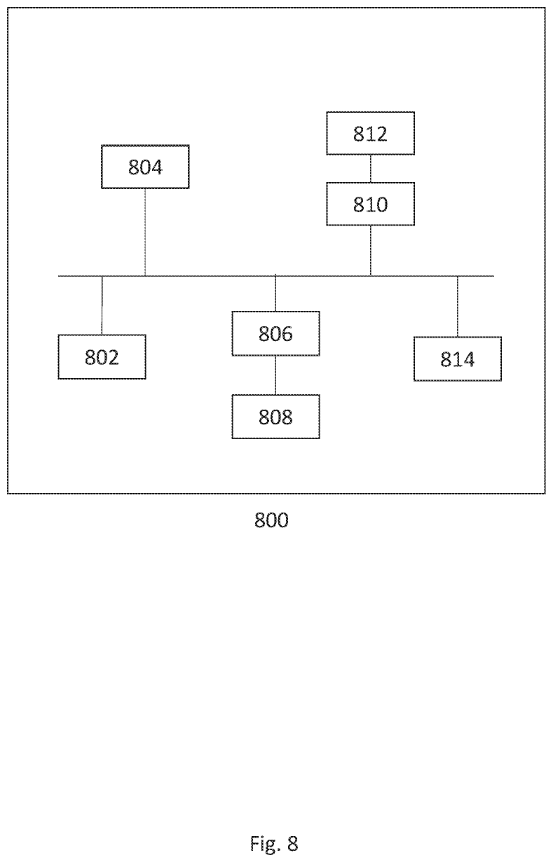

FIG. 8 shows a schematic and simplified representation of a computer apparatus 800 which can be used to perform the methods described herein, either alone or in combination with other computer apparatuses. The computer apparatus 800, or components thereof, may be incorporated into a device, such as a digital keyboard, comprising the control mechanisms of the present disclosure. Alternatively, the computer apparatus 800 may be provided externally to the device comprising the control mechanisms of the present disclosure.

The computer apparatus 800 comprises various data processing resources such as a processor 802 coupled to a central bus structure. Also connected to the bus structure are further data processing resources such as memory 804. A display adapter 806 connects a display device 808 to the bus structure. One or more user-input device adapters 810 connect a user-input device 812, such as the keys or other input mechanisms of the present disclosure to the bus structure. One or more communications adapters 814 are also connected to the bus structure to provide connections to other computer systems 800 and other networks.

In operation, the processor 802 of computer system 800 executes a computer program comprising computer-executable instructions that may be stored in memory 804. When executed, the computer-executable instructions may cause the computer system 800 to perform one or more of the methods described herein. The results of the processing performed may be displayed to a user via the display adapter 806 and display device 808. User inputs for controlling the operation of the computer system 800 may be received via the user-input device adapters 810 from the user-input devices 812.

It will be apparent that some features of computer system 800 shown in FIG. 8 may be absent in certain cases. For example, one or more of the plurality of computer apparatuses 800 may have no need for display adapter 806 or display device 808. Similarly, user input device adapter 810 and user input device 812 may not be required. In its simplest form, computer apparatus 800 comprises processor 802 and memory 804.

In the foregoing, the singular terms “a” and “an” should not be taken to mean “one and only one”. Rather, they should be taken to mean “at least one” or “one or more” unless stated otherwise. The word “comprising” and its derivatives including “comprises” and “comprise” include each of the stated features but does not exclude the inclusion of one or more further features.

Those skilled in the art will recognize that a wide variety of modifications, alterations, and combinations can be made with respect to the above described embodiments without departing from the scope of the disclosed concepts, and that such modifications, alterations, and combinations are to be viewed as being within the ambit of the disclosed concepts.

The approaches described herein may be embodied on a computer-readable medium, which may be a non-transitory computer-readable medium. The computer-readable medium carrying computer-readable instructions arranged for execution upon a processor so as to make the processor carry out any or all of the methods described herein.

The term “computer-readable medium” as used herein refers to any medium that stores data and/or instructions for causing a processor to operate in a specific manner. Such storage medium may comprise non-volatile media and/or volatile media. Non-volatile media may include, for example, optical or magnetic disks. Volatile media may include dynamic memory. Exemplary forms of storage medium include, a floppy disk, a flexible disk, a hard disk, a solid state drive, a magnetic tape, or any other magnetic data storage medium, a CD-ROM, any other optical data storage medium, any physical medium with one or more patterns of holes, a RAM, a PROM, an EPROM, a FLASH-EPROM, NVRAM, and any other memory chip or cartridge.

1. A method for distributing audio digital signal processing (DSP) code, comprising:
receiving audio DSP source code at an application programme interface (API), the audio DSP source code being written in a first programming language; wherein the first programming language is a special-purpose language for audio signal processing applications;
translating the audio DSP source code into an intermediate representation (IR), wherein the IR comprises a directed-graph (di-graph) representation of the audio DSP source code, the di-graph comprising a plurality of nodes and connections, where each node comprises a DSP program for performing an audio signal processing task;
detecting a target device which advertises its ability to execute the IR; and
transmitting the IR to the detected target device for execution.

2. The method of claim 1, further comprising executing the IR at the target device, wherein the executing the IR at the target device comprises compiling the IR using a just-in-time compiler.

3. The method of claim 2, wherein the target device comprises multiple processor cores, and the executing the IR further comprises splitting the code into two or more sections which can execute in parallel using the multiple processor cores.

4. The method of claim 2, wherein the executing the IR includes instantiating a communication channel between the API and the target device, and the method further comprises:
transmitting control event data to control one or more properties of the executing IR, and
transmitting audio data to the target device to be used as one or more inputs to the plurality of nodes in the di-graph.

5. The method of claim 2, wherein executing the IR comprises producing audio at the target device.

6. The method of claim 1, wherein the nodes and connections define one or more program paths, and wherein the detecting the target device includes obtaining target device characteristics for the detected target device.

7. The method of claim 6, further comprising modifying the one or more program paths based on the obtained target device characteristics.

8. The method of claim 6, wherein the di-graph comprises a plurality of program paths, the method further comprising modifying the one or more program paths based on the obtained target device characteristics wherein the modifying the one or more program paths comprises merging program paths into a single thread for executing at the target device.

9. The method of claim 1, wherein the target device comprises a driver interface compatible with the IR.

10. A method according to claim 1, wherein each node of the di-graph may be a processor node, comprising an IR code program to:
read input data from a node input;
perform a first process on the input data; and
write output data to a node output.

11. An apparatus for executing audio digital signal processing (DSP) code, comprising:
a processor; and
a transceiver;
the apparatus being arranged to:
receive DSP code from an Application Programming Interface (API), the DSP code being an Intermediate Representation (IR) of audio DSP source code, the audio DSP source code being written in a first programming language, wherein the first programming language is a special-purpose language for audio signal processing applications, wherein the IR comprises a directed-graph (di-graph) representation of the audio DSP source code, the di-graph comprising a plurality of nodes and connections; and
the processor being arranged to execute the DSP code.

12. The apparatus according to claim 11, wherein the processor is further arranged to compile the IR using a just-in-time compiler.

13. The apparatus according to claim 11, further comprising:
an audio driver, and
an output device, the apparatus being arranged to produce audio at the output device from the executed DSP code.

14. The apparatus according to claim 13, wherein the audio driver is compatible with the IR.

15. The apparatus according to claim 11, wherein the apparatus is arranged to receive control event data at the transceiver while the DSP code is being executed, the control event data arranged to control one or more properties of the executed DSP code.

16. The apparatus according to claim 11, wherein executing the DSP code comprises modifying the di-graph in relation to one or more device properties of the apparatus, the device properties including a number of processor cores.

17. The apparatus according to claim 16, wherein the processor comprises a plurality of processor cores, and the executing of the DSP code further comprises splitting the DSP code into two or more sections which can execute in parallel using the plurality of processor cores.

18. A non-transitory computer-readable storage medium, comprising instructions thereon, which, when executed by a processor, cause the processor to perform a method for distributing digital signal processing (DSP) code, the method comprising:
receiving audio DSP source code at an application programme interface API, the audio DSP source code being written in a first programming language, wherein the first programming language is a special-purpose language for audio signal processing applications;
translating the audio DSP source code into an intermediate representation (IR), wherein the IR comprises a directed-graph (di-graph) representation of the audio DSP source code, the di-graph comprising a plurality of nodes and connections, where each node comprises a DSP program for performing an audio signal processing task;
detecting a target device which advertises its ability to execute the IR; and
transmitting the IR to the detected target device for execution.
